(19) United States
(12) Patent Application Publication
(10) Pub. No.: US 2016/0014347 A1
(43) Pub. Date: Jan. 14, 2016

(54) DIGITAL COMPOSITING OF LIVE ACTION AND ANIMATION

(71) Applicant: Stephen Van Eynde, Washington, DC (US)

(72) Inventor: Stephen Van Eynde, Washington, DC (US)

(21) Appl. No.: 14/797,937

(22) Filed: Jul. 13, 2015

Related U.S. Application Data
(60) Provisional application No. 62/023,561, filed on Jul. 11, 2014.

(51) Int. Cl. H04N 5/265; G11B 27/036; H04N 5/272; G06T 13/80

(52) U.S. Cl. CPC H04N 5/265; G06T 13/80; G11B 27/036; H04N 5/272

(57) ABSTRACT

In a new computer implemented method for digital compositing of live action and animation video clips, a digital live action video layer is received, a digital animation layer is generated without a background, a time and location in the digital live action video layer where the digital animation layer must be superimposed is determined, the digital animation layer is superimposed over the live action video layer at the determined time and location, the superimposition is continued over the length of the live action video layer, with location selection adjusted as needed, and a composite digital video is output.

This application claims the benefit of U.S. Provisional Application No. 62/023,561, filed Jul. 11, 2014, which is hereby incorporated by reference in its entirety.

### FIELD OF THE INVENTION

The present invention relates generally to the field of video technology, and more particularly to video compositing.

### BACKGROUND

Compositing (blending) of live action footage with animation is a technique that has been done for years in many ways. The earliest example was in 1919 with the silent film “Out of the Inkwell”. In films such as Disney's “Mary Poppins,” the blending of live action and animation was achieved by a process known as chroma keying. Chroma keying allows for the separation or masking of foreground elements to be placed over new backgrounds. This typically involves a blue or green screen background that will act as a neutral or empty space and used for making a mask, also known as a matte, to be created for the foreground elements. Luminance keying is a process that uses various degrees of black and white to composite multiple elements. If we were to think in terms of film, white would act as the most exposed part of the emulsion leaving nothing for re-exposure. Black, in return, would register as untouched/empty and completely ready for exposure. Today's digital matting process is based on this principle.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

A new compositing process involves the layering of two or more digital video clips. The first is the live action footage, which acts as a background plate. The second and uppermost layer is the animation. Since the animation is created over an “empty” background from the beginning, there is no need for the creation of mattes or masks. This is different from the editing process that requires the use of mattes or masks, which can be found in the video clip's alpha channels (sublevels of information beyond R, G, & B). A tool that may be used for the compositing process is Adobe's After Effects. This may also be achieved using Flash or some other visual effects compositing tool such as Shake, Flint, Inferno, etc.

In a new computer implemented method for digital compositing of live action and animation video clips, a digital live action video layer is received, a digital animation layer is generated without a background, a time and location in the digital live action video layer where the digital animation layer must be superimposed is determined, the digital animation layer is superimposed over the live action video layer at the determined time and location, the superimposition is continued over the length of the live action video layer, with location selection adjusted as needed, and a composite digital video is output.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a representation of a digital animation layer, in an embodiment.

FIG. 2 is a representation of the digital animation layer at a different time, in an embodiment.

FIG. 3 is a representation of a digital live action layer, in an embodiment.

FIG. 4 is a representation of a composite of the digital animation layer and the digital live action layer, in an embodiment.

FIG. 5 is a block diagram illustrating a live action and animation digital composition system, in an embodiment.

FIG. 6 illustrates a method for digital compositing of live action and animation, in an embodiment.

### DETAILED DESCRIPTION

Digital corn positing of live action and animation will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

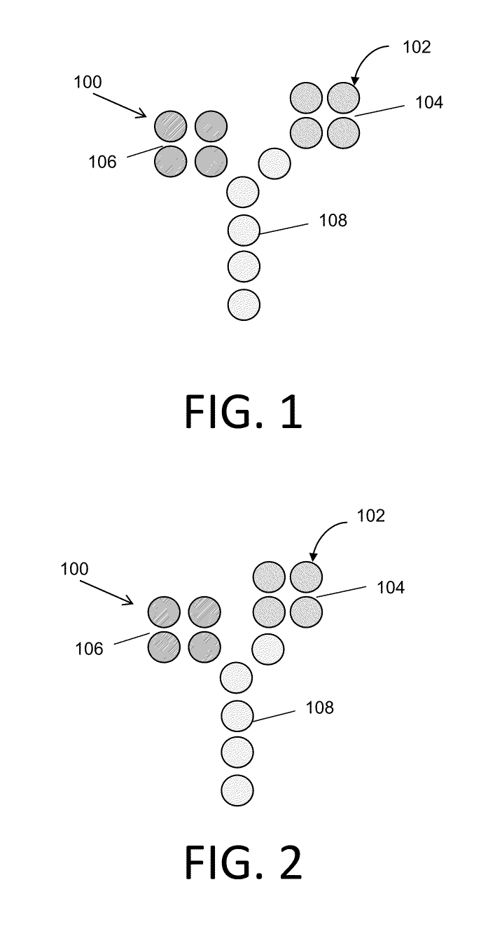

FIG. 1 is a representation of a digital animation layer, in an embodiment. In this simple example, a digital animation layer 100 is composed of a number of pixels 102, each having color and location information. For example, each pixel may have an rgb value and an x-y coordinate. The number of pixels and/or their color and/or location changes over time to create the animation. Thus, there may be a number of sets of pixels and associated color and location values, each associated with a particular video time. By displaying the sets in sequence as the video time runs, the animation is displayed. In this example, an image of a flower bunch is constructed from 13 pixels 102 in three different color groups 104, 106, 108, representing two flowers and a stem.

FIG. 2 is a representation of the digital animation layer at a different time, in an embodiment. Here four pixels, representing one of the flowers 104, have moved. The change between the previous time (shown in FIG. 1) and this time may create an animation of the flower bunch moving in, e.g., wind.

Because the digital animation layer 100 of FIGS. 1-2 is created digitally, it need only contain the information desired by the creator and no more. Thus, objects may be created independently of any background. Here, the only pixels 102 in the layer are those making up the desired image (flower bunch). There is no color or other pixel information associated with locations between the thirteen pixels. For example, one may extrapolate from the known coordinates of the two flowers that in “real life” there would be something in between them (e.g. air), however there is no information pertaining to such locations in the digital animation layer. Thus, in FIGS. 1-2 there is no background.

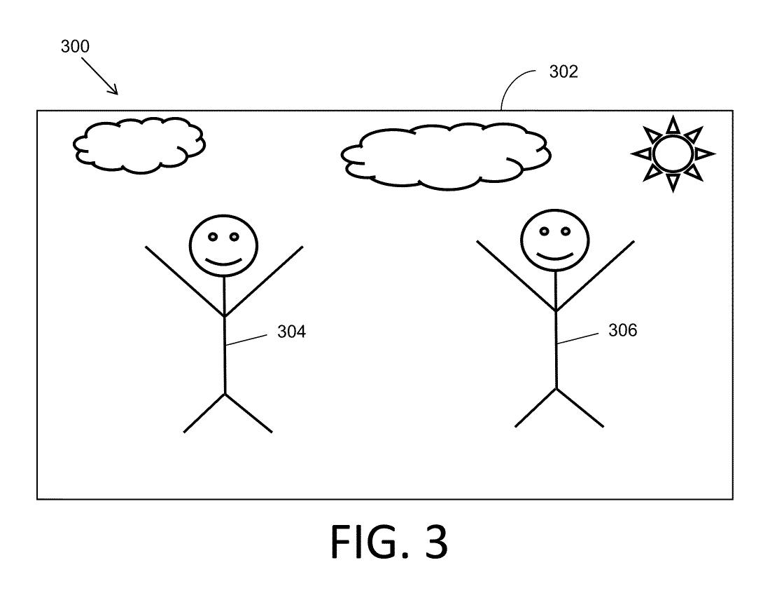

FIG. 3 is a stylized representation of a digital live action video layer 300, in an embodiment. Since live action is shot using a camera, in this example the live action layer takes up the entire field of view 302 of the camera used to record it. This entire field of view has associated digital video information (color, etc.) although certain objects (e.g. 304, 306) in the live action layer may be the focus of the live action video.

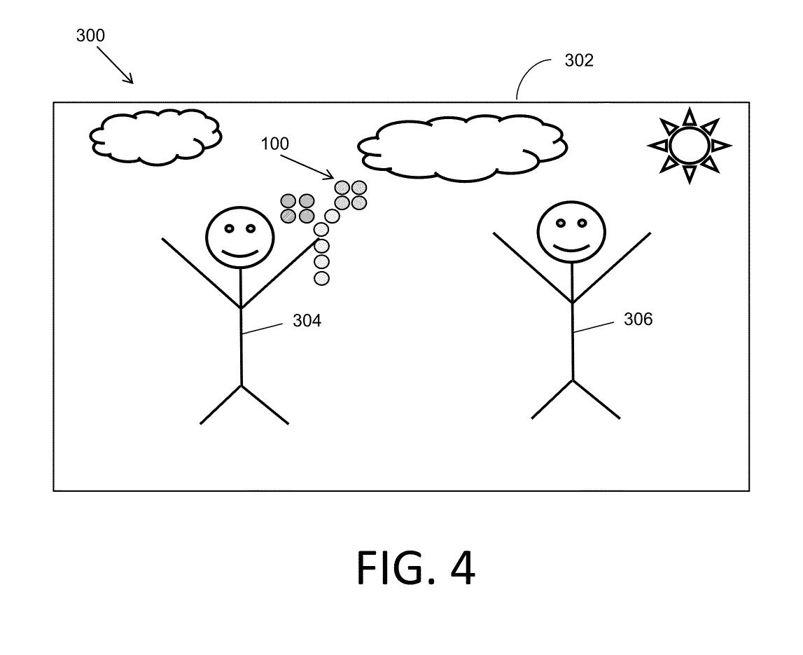

FIG. 4 is a representation of a composite of the digital animation layer and the digital live action layer, in an embodiment. The live action video layer 300 of FIG. 3 acts as a first layer and background plate. The second and uppermost layer is the digital animation layer 100 of FIG. 1. Since the animation was created over an “empty” background from the beginning, there is no need for the creation of mattes or masks. The digital animation layer 100 is superimposed on the background plate 300, such that that color values of the animation layer pixels 102 replace the color values on the background plate 300 they are placed over. The digital animation layer may be placed anywhere desired on the background plate. For example, in FIG. 4 the digital animation layer 100 is placed so that the flower bunch is superimposed over the live action character's 304 hand so that the character 304 appears to be carrying it. In another example, the digital animation layer may comprise an animated character, which may be superimposed between the live action characters so that it appears to be interacting in some way with the live action characters, for example speaking with them. In another embodiment, the animated character may be superimposed on any live action video and act as a narrator, moving around on top of the live action video and pointing out and discussing various features therein.

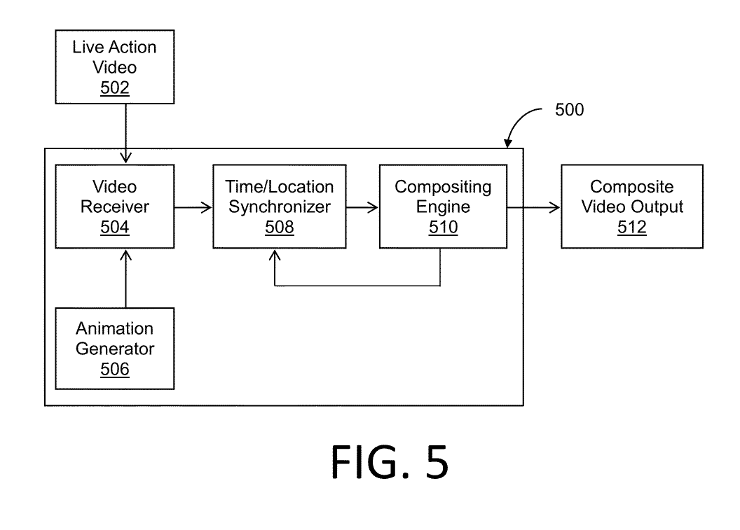

FIG. 5 illustrates a live action and animation digital composition system, in an embodiment. Video receiver 504, which may be a video receiver module, receives digital live action video 502. Digital live action video 502 may come from a local or remote digital storage or be a live stream such as from a digital video camera. In some embodiments, the digital composition system may include an electronic storage for live action video(s). Animation generator 506, which may be an animation generator module, creates a digital animation with no background and sends it to the video receiver 504. In some embodiments, video receiver 504 may receive a digital animation layer from outside the digital composition system rather than from an animation generator 506 within the system. In other embodiments, video receiver 504 may receive a digital animation layer from an electronic storage within the digital composition system. Video receiver 504 may request or retrieve the live action video 502 and/or digital animation as needed/desired.

Video receiver 504 transmits the digital live action video 502 and digital animation to the time and location synchronizer 508, which may be a time and location synchronization module. The time and location synchronizer 508 determines the appropriate location for the digital animation to be inserted into the digital live action video 502 and synchronizes the timing of each. For example, the digital animation may be intended for inclusion in the digital live action video only during certain portions thereof. This, the digital animation may be ten minutes long while the digital live action video is twenty minutes long. The first five minutes of the digital animation may be intended to be superimposed on the digital live action video starting at the 5:00 mark of the live action video, and the second five minutes of the digital animation may be intended to be superimposed on the digital live action video starting at the 15:00 mark of the live action video. Time and location synchronizer 508 determines this information and passes it, and the location information, to the compositing engine 510.

Compositing engine 510, which may be a compositing engine module, uses the time and location synchronization information and layers the digital live action video clip with the digital animation video clip. The digital live action video is used as a background plate and the digital animation video is layered on top of the background plate. The digital animation video is superimposed on the digital live action video at the time and location determined by the time and location synchronizer 508. Since the digital animation video has no background, no mattes or masks are used. The layering creates a composite video 512 which is output by the compositing engine 510.

In some embodiments, compositing engine 510 may call the time and location synchronizer 508 as needed. For example, the digital animation video and/or digital live action video may include information indicating breaks (i.e. chapter breaks), and after each break a new location may be determined for the digital animation layer. Alternatively, the time/location synchronizer 508 may determine all necessary locations and times in advance. In some embodiments, compositing engine 510 may directly receive the live action video 502 and digital animation video output from animation generator 506 or elsewhere and call the time/location synchronizer directly as needed (thus in such embodiments, time/location synchronizer 508 may communicate only with the compositing engine 510). In some embodiments, the time and location synchronizer 508 may be integrated into the compositing engine 510.

In some embodiments, the compositing engine 510 may receive multiple digital animation videos to combine with a single live action video 502. The digital animation videos may be received all at once or one/some at a time during the compositing process. Each digital animation video may require its own time/location information for composition with the digital live action video 502.

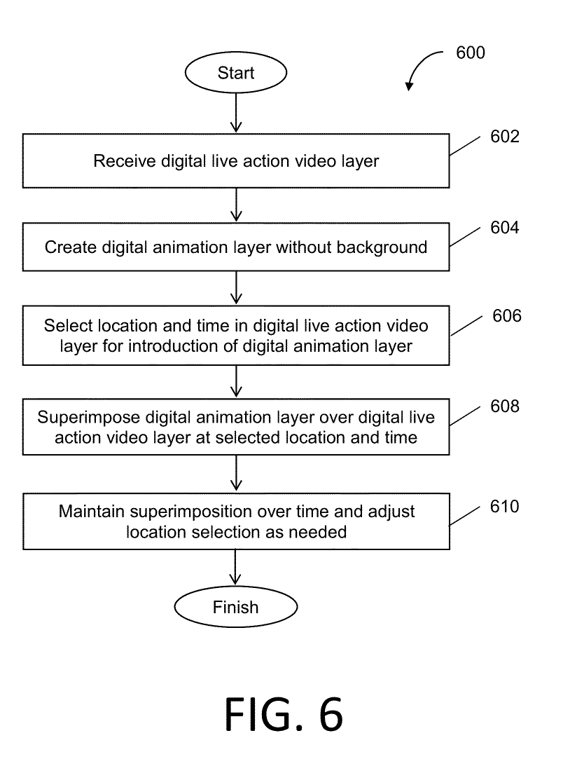

FIG. 6 illustrates a method 600 for digital compositing of live action and animation, in an embodiment. The operations of method 600 presented below are intended to be illustrative. In some embodiments, method 600 may be accomplished with one or more additional operations not described, and/or without one or more of the operations discussed. Additionally, the order in which the operations of method 600 are illustrated in FIG. 6 and described below is not intended to be limiting.

In some embodiments, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At an operation 602, a digital live action video layer may be received. The live action video layer may be received from local or remote digital storage, or may be received as a live stream. In embodiments, the live action video layer may be actively retrieved as needed/desired. Operation 602 may be performed by a video receiver that is the same as or similar to video receiver 504, in accordance with one or more implementations.

At an operation 604, a digital animation layer is created without a background. Operation 604 may be performed by an animation generator that is the same as or similar to animation generator 506, in accordance with one or more implementations.

At an operation 606, a time and location in the digital live action video layer are selected for superimposition of the digital animation layer. Operation 606 may be performed by a time and location synchronizer that is the same as or similar to time and location synchronizer 508, in accordance with one or more implementations.

At an operation 608, the digital animation layer is superimposed over the live action video layer at the selected time and location. Operation 608 may be performed by a compositing engine that is the same as or similar to compositing engine 510, in accordance with one or more implementations.

At an operation 610, the superimposition is continued over the length of the live action video layer, with location selection adjusted as needed. Operation 610 may be performed by a compositing engine and/or time and location synchronizer that are the same as or similar to compositing engine and/or time and location synchronizer 508, 510, in accordance with one or more implementations.

The invention is not limited to the particular embodiments illustrated in the drawings and described above in detail. Those skilled in the art will recognize that other arrangements could be devised, for example, using various combinations of hardware and software to implement the functions described with regard to the digital composition system. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application While the invention has been described with reference to specific illustrative embodiments, modifications and variations of the invention may be constructed without departing from the spirit and scope of the invention as set forth in the following claims.

I claim:

1. A computer implemented method for digital compositing of live action and animation video clips, comprising:
receiving a digital live action video layer;
generating a digital animation layer without a background;
determining a time and location in the digital live action video layer where the digital animation layer must be superimposed;
superimposing the digital animation layer over the live action video layer at the determined time and location;
continuing the superimposition over the length of the live action video layer, with location selection adjusted as needed; and
outputting a composite digital video.
